(19) United States
(12) Patent Application Publication
(10) Pub. No.: US 2003/0131493 A1
(43) Pub. Date: Jul. 17, 2003

(54) Wafer temperature compensator having reflector

(76) Inventor: Tae-Wan Lee, Seoul (KR)

Correspondence Address: BAKER & DANIELS, 300 NORTH MERIDIAN STREET, SUITE 2700, INDIANAPOLIS, IN, 46204-1782, US

(21) Appl. No.: 10/331,406

(22) Filed: Dec. 30, 2002

(30) Foreign Application Priority Data
Jan. 4, 2002 (KR) 2002-493

(51) Int. Cl. F26B 3/34

(52) U.S. Cl. 34/266; 34/273; 34/107; 34/202

(57) ABSTRACT

An apparatus for manufacturing a semiconductor device having a process chamber comprises a lower process chamber wall, a quartz dome over the lower process chamber wall, a pumping mean for making an interior of the process chamber vacuous, a bell-jar over the quartz dome, a bell-jar heater built in a side of the bell-jar, a susceptor on which a wafer is loaded, a susceptor heater built in the susceptor, and a wafer temperature compensator having a reflector plate and supporting elements, the reflector plate being spaced apart a certain distance from the wafer and having a larger area than that of the wafer, the supporting elements being connected to the wafer and supporting edges of a bottom surface of the wafer.

This application claims the benefit of Korean Patent Application No. 2002-00493, filed on Jan. 4, 2002 in Korea, which is hereby incorporated by reference for all purposes as if fully set forth herein.

### BACKGROUND OF THE INVENTION

1. Field of the Invention

The present invention relates to an apparatus for manufacturing a semiconductor device and more particularly, to a wafer temperature compensator that is installed on a susceptor of a process chamber to provide a stable temperature condition of a wafer and thus improve a uniformity of temperature distribution of the wafer.

2. Discussion of the Related Art

A development for a new material has been actively performed in the field and diverse large-scale integrated circuit (LSI) such as ultra large-scale integrated circuit (ULSI) has been developed due to a rapid growth of the new material development. That is, because the new material for forming thin films such as an insulating layer, a semiconductor layer and a conductor layer, which constitute a semiconductor device, has been developed widely in the field, the large-scale integrated circuit (LSI) such as the ultra large-scale integrated (ULSI) circuit is available now. The semiconductor devices are generally fabricated by repeated depositing and patterning process. These processes are accomplished in a manufacturing apparatus of the semiconductor device under vacuum condition.

Generally, a deposition apparatus for manufacturing semiconductor device has a heater in a process chamber to heat a wafer up to a certain process temperature required. FIG. 1 is a cross-sectional view of a conventional process chamber for manufacturing a semiconductor device. In FIG. 1, the process chamber mainly has a lower wall 100 and a quartz dome 120. Once a manufacturing process for the semiconductor device is commenced, a silicon wafer 130 is loaded onto a susceptor 110 that has a built-in susceptor heater 135. The wafer 130 is also heated up by a bell-jar heater 150 that is built in a bell-jar 160. The process chamber equipped with the bell-jar heater 150 is called as a warm-wall type process chamber. If the wafer 130 reaches a certain temperature and keeps a constant temperature, process gases are injected into the process chamber through an injector 140 to grow an epitaxial layer on the wafer 130 and form a chemical vapor deposition film on the wafer 130. The wafer 130 receives the heat mainly from the susceptor 110 that is adjacent to the wafer 130 while it receives a little amount of heat from the bell-jar heater 150. Because the wafer 130 contacts the susceptor 110 and the quartz dome 120 is spaced apart from the wafer 130, an amount of the heat that radiates from a top surface of the wafer 130 is greater than an amount of the radiant heat from a bottom surface of the wafer 130. Moreover, because an interior of the process chamber keeps a high vacuum state by a highly efficient pump (not shown) such as a turbo pump, an uniformity of a thickness of the epitaxial layer is more affected by a temperature uniformity of the wafer surface rather than a flow condition of the process gases. That is, the conventional process chamber module for manufacturing semiconductor devices has disadvantages as follows. Firstly, because the susceptor 110 is a main heat source for heating up the wafer 130 and thus the amount of the radiated heat from the top surface of the wafer 130 is so large, the wafer 130 fails to keep a required temperature for the process. Accordingly, it is hard to keep the wafer temperature stably at 800° C. for processing the surface of the wafer 130. Secondly, because the amount of the radiated heat from the top surface of the wafer 130 is great and thus there occurs a great difference of temperature gradient between the top surface of the wafer 130 and the bottom surface of the wafer 130, the uniformity of the wafer temperature becomes deteriorated. Therefore, an object of the present invention is to provide a wafer temperature compensator to reduce an amount of radiant heat from the heated wafer 130.

### SUMMARY OF THE INVENTION

Accordingly, the present invention is directed to a manufacturing apparatus for a semiconductor device that substantially obviates one or more of problems due to limitations and disadvantages of the related art.

An advantage of the present invention is to provide a manufacturing apparatus for a semiconductor device that is equipped with a wafer temperature compensator having a reflector to reduce an amount of radiated heat from the wafer and thus achieve a uniform temperature distribution of the wafer.

Additional features and advantages of the invention will be set forth in the description which follows, and in part will be apparent from the description, or may be learned by practice of the invention. The objectives and other advantages of the invention will be realized and attained by the structure particularly pointed out in the written description and claims hereof as well as the appended drawings.

To achieve these and other advantages and in accordance with the purpose of the present invention, as embodied and broadly described, an apparatus for manufacturing a semiconductor device having a process chamber comprises a lower process chamber wall, a quartz dome over the lower process chamber wall, a pumping mean for making an interior of the process chamber vacuous, a bell-jar over the quartz dome, a bell-jar heater built in a side of the bell-jar, a susceptor on which a wafer is loaded, a susceptor heater built in the susceptor, and a wafer temperature compensator having a reflector plate and supporting elements, the reflector plate being spaced apart a certain distance from the wafer and having a larger area than that of the wafer, the supporting elements being connected to the susceptor and supporting edges of a bottom surface of the wafer. The reflector plate is parallel with the wafer. The reflector plate reflects a radiant heat in a range of infrared rays that is radiated from the wafer. The reflector plate is formed of molybdenum (Mo). The bottom surface of the wafer is flat. The bottom surface of the wafer may alternatively be concave.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention.

In the drawings:

FIG. 1 is a cross-sectional view of a conventional process chamber for manufacturing a semiconductor device;

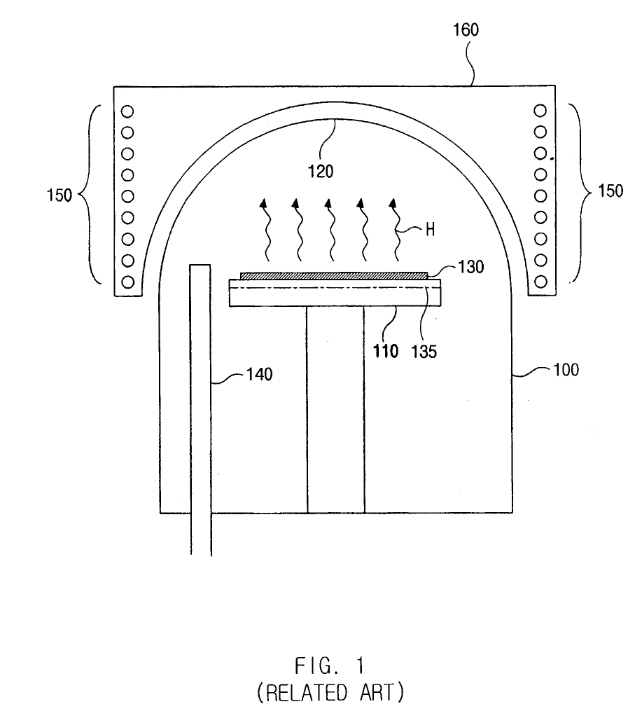

FIG. 2 is a cross-sectional view of a process chamber for manufacturing a semiconductor device according to a first embodiment of the present invention;

FIG. 3 is a cross-sectional view of a wafer temperature compensator according to a second embodiment of the present invention.

### DETAILED DESCRIPTION OF THE ILLUSTRATED EMBODIMENTS

Reference will now be made in detail to the illustrated embodiment of the present invention, which is illustrated in the accompanying drawings.

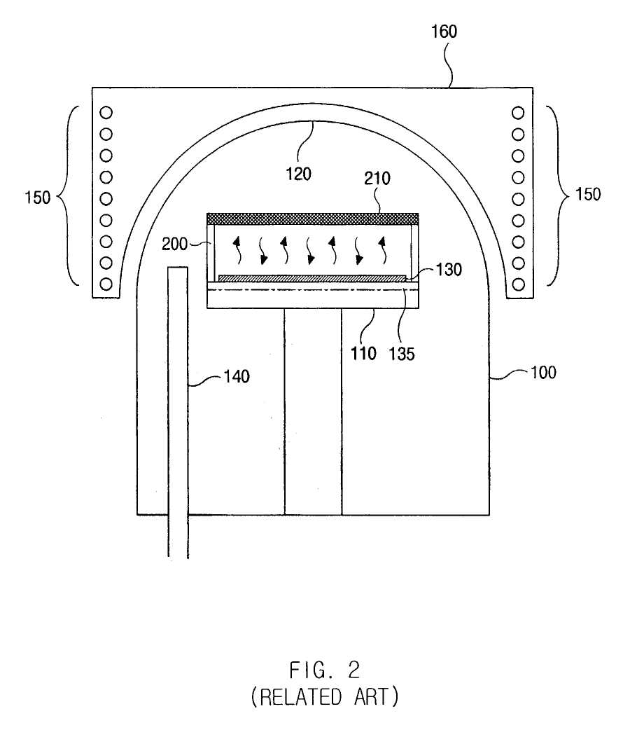

FIG. 2 is a cross-sectional view of a process chamber for manufacturing a semiconductor device according to a first embodiment of the present invention. A general structure of the process chamber module according to the present invention is same as that of the conventional process chamber module. In FIG. 2, the process chamber mainly has a lower wall 100 and a quartz dome 120. Once a manufacturing process for the semiconductor device is commenced, a silicon wafer 130 is loaded onto a susceptor 110 that has a built-in susceptor heater 135. The wafer 130 is also heated up by a bell-jar heater 150 that is built in a bell-jar 160. The present invention further comprises a reflector plate 210 that is formed of molybdenum (Mo) and a plurality of supporting elements 200. The supporting elements 200 are connected to the susceptor 110 and contact edges of the reflector plate 210. The reflector plate 210 is spaced apart from the susceptor 110. The reflector plate 210 has a larger area than the wafer 130 and may be formed parallel with the wafer 130. Accordingly, radiant heat from the wafer 130 is reflected at the reflector plate and then absorbed to the wafer 130 again. On the other hand, because the bell-jar heater 150 is disposed at sides of the bell jar 160, radiant heat from the bell-jar heater 150 is not greatly reflected by the reflector plate 210. That is, though the reflector plate 210 may hinder radiant heat of the bell-jar heater 150 from reaching the wafer 130, this effect is negligible compared to an effect of the returned heat on the wafer 130 by the reflector plate 210. Therefore total heat efficiency of the process chamber will be increased. Besides, because the wafer 130 is processed under vacuum condition in the process chamber, an interception of the process gases from the injector 140 to the wafer 130 does not need to be considered.

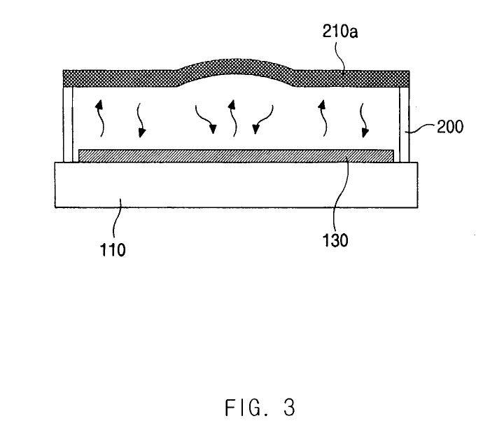

FIG. 3 is a cross-sectional view of a wafer temperature compensator according to a second embodiment of the present invention. In FIG. 3, a reflector plate 210a has a concave bottom surface corresponding to the wafer 130. The concave reflector plate 210a converges the reflected radiant heat from the wafer 130 into a center portion of the wafer 130. Heat flows of the radiant heat that is radiated from the wafer 130 to the reflector plate 210a and the reflected heat at the surface of the concave reflector plate 210a are illustrated in FIG. 3. Accordingly, this concave shape of the reflector plate 210a gives greater temperature compensation effect on the center potion of the wafer 130 than other portions of the wafer 130. On the other hand, if the reflector plate 210a has a convex bottom surface, the convex shape of the reflector plate 210 will give greater temperature compensation effect on edge portions than the center portion of the wafer 130. A temperature distribution of the wafer 130 depends mainly on a structure of the susceptor heater 135 that is built in the susceptor 110. Accordingly, once information on the temperature distribution of the wafer is known, a portion of the wafer 130 that needs temperature compensation can be decided and thus a shape of the bottom surface of the wafer 130 can be decided according to the portion requiring the temperature compensation. Therefore, a reflector plate structure of the wafer temperature compensator is not confined to the above stated shapes and can be modified diversely in many ways depending on the situation.

With a help of the present invention, a wafer temperature can be heated up to 800° C. (centigrade) stably and temperature uniformity can be improved. Accordingly, a uniformity of thickness of a deposited film on the wafer can be improved.

It will be apparent to those skilled in the art that various modifications and variation can be made in the fabrication and application of the present invention without departing from the spirit or scope of the invention. Thus, it is intended that the present invention cover the modifications and variations of this invention provided they come within the scope of the appended claims and their equivalents.

What is claimed is:

1. An apparatus for manufacturing a semiconductor device having a process chamber, comprising:
a lower process chamber wall;
a quartz dome over the lower process chamber wall;
a pumping mean for making an interior of the process chamber vacuous;
a bell-jar over the quartz dome;
a bell-jar heater built in a side of the bell-jar;
a susceptor on which a wafer is loaded;
a susceptor heater built in the susceptor; and
a wafer temperature compensator having a reflector plate and supporting elements, the reflector plate being spaced apart a certain distance from the wafer and having a larger area than that of the wafer, the supporting elements being connected to the susceptor and supporting edges of a bottom surface of the wafer.

2. The apparatus according to claim 1, wherein the reflector plate is parallel with the wafer.

3. The apparatus according to claim 1, wherein the reflector plate reflects a radiant heat in a range of infrared rays that is radiated from the wafer.

4. The apparatus according to claim 3, wherein the reflector plate is formed of molybdenum (Mo).

5. The apparatus according to claim 3, wherein the bottom surface of the wafer is flat.

6. The apparatus according to claim 3, wherein the bottom surface of the wafer is concave.
